(19) United States
(12) Patent Application Publication
(10) Pub. No.: US 2020/0320440 A1
(43) Pub. Date: Oct. 8, 2020

(54) System and Method for Use in Training Machine Learning Utilities

(71) Applicant: AGENT VIDEO INTELLIGENCE LTD., Rosh HaAyin (IL)

(72) Inventors: Zvika ASHANI, Ganey Tikva (IL); Mor DAR, Yavne (IL)

(21) Appl. No.: 16/954,744

(22) PCT Filed: Dec. 12, 2018
(86) PCT No.: PCT/IL2018/051351

§ 371 Date: Jun. 17, 2020

(30) Foreign Application Priority Data
Dec. 21, 2017 (IL) 256480

(51) Int. Cl. G06N 20/20; G06K 9/62

(52) U.S. Cl. CPC G06N 20/20; G06K 9/6263; G06K 9/6257; G06K 9/6215

(57) ABSTRACT

A method for use in generating training data set and in training a learning utility is provided. The method comprising: providing a first set of labeled data and an ensemble of second learning utilities; training the ensemble of second utilities to label data, using the first set of labeled data; providing a second set of unlabeled data; labeling at least one portion of the second set of unlabeled data using the ensemble in order to generate corresponding first labels for said at least one portion of the second set to thereby yield a third set of data pieces corresponding to said at least one portion of the second set and labels thereof; and training the first utility using said third set of data pieces.

### TECHNOLOGICAL FIELD

The present invention, relates to the field of computing and more specifically to machine learning and corresponding labeled datasets.

### BACKGROUND

Machine learning is a field of computer science that gives computers the ability to learn to accomplish tasks without being explicitly programmed to do so. The uses of machine learning cover a wide range of domains from image classification, language translation, signal analysis and much more. By nature, machine learning relies on the availability of large data sets on which suitable algorithms can be trained. In many cases it has been shown that a direct relationship exists between the size of the training data set and the accuracy of processing by the trained algorithm.

Machine learning techniques generally fall into one of two categories: supervised and unsupervised. In supervised learning, each sample in the training data is annotated with what is called the “ground truth” or expected results. For example, in the case of image classification each image has a label describing its content. In unsupervised learning, the data is not annotated at all and the machine learning utility learns on its own by analyzing the structure and distribution of the training data and without being told in advance the expected results. Supervised learning is currently much more widely used than unsupervised learning since it has been proven to generate better results in many cases.

### GENERAL DESCRIPTION

One of the main challenges of supervised machine learning is the creation of annotated/labeled data sets for training purposes. Since this is mostly a manual process, it can be time consuming and costly. This is especially true with the best performing class of machine learning utility called Deep Learning, which is able to provide state of the art results in many cases, but requires very large amounts of training data.

There is therefore a need for a technique for uses in training a machine learning utility for selected processing tasks, e.g. annotating/labeling data, by using training data that is automatically annotated. Additionally or alternatively, there is a need for a technique for automatic annotation of large sets of data pieces, for generating annotated training data based on pre-provided sample set, which is previously annotated.

The technique of the present invention utilizes an ensemble of machine learning utilities (herein referred to as second machine learning utilities or as ensemble for simplicity) to provide automated labeling for previously unlabeled data. The labels determined by the ensemble are then used for labeling the data set and training a first/primary machine learning utility. This enables low-cost technique for generating large volumes of labeled data, which would otherwise require costly and time consuming manual labeling process.

As mentioned above, the accuracy of processing by machine learning utilities generally improves with the amount of data used for training thereof. Accordingly, it is generally desirable to use a large volume of training dataset. However generating labels for large dataset is typically time consuming and costly.

An advantage of the present technique lies in the fact that an ensemble of machine learning utilities usually provides a larger range of labels that generally, might average to a more accurate label than is provided by a single machine learning utility. The ensemble can be as large as needed and may preferably include a plurality of machine learning utilities of different topologies, hyper parameters and random initializations. For simplicity, the machine learning utilities of the ensemble are herein referred to as second utilities. The second utilities of the ensemble typically make different mistakes, more specifically, not all of the utilities of the ensemble make the same mistakes. Therefore, when there is majority agreement on, or around, a specific result, there is high likelihood that the ensemble's labeling is more accurate than labeling by a single machine learning utility.

Using an ensemble of machine learning utilities for general processing (i.e. as the primary machine learning utility) typically requires significantly higher processing resources (corresponding to power, time and cost) than running a single machine learning utility. However, for the purpose of labelling data for training a machine learning utility, the ensemble can be run offline, and the amount of computational resources dedicated to the ensemble can be controlled. In this manner, the cost for processing input data and determining corresponding labels for training one or more machine learning utilities can be decreased, as compared to the conventional labeling techniques. This provides for generating large volumes of labeled training data, enabling training one or more primary machine learning utilities for increased processing accuracy as compared to that achieved based on smaller volume of training data.

As indicated above, the ensemble of machine learning utilities may preferably comprise two or more machine learning utilities having different processing topologies, which may preferably be different than the topology of the primary machine learning utility. Accordingly, output labeling data generated in response to similar input data pieces may be different between each machine learning utility, while being within an acceptable range which indicates agreement on a label.

Thus, the present technique provides a method for use in training a machine learning utility (herein referred to as first or primary utility), the method comprising: providing a first set of labeled data and an ensemble of second learning utilities, and using the first set for training the ensemble of second utilities for determining labels. Further, the method comprises: providing a second set of data pieces that are not labeled, and using the ensemble for inferring data pieces of the second set to determine corresponding labels; processing the output labels associated with each data piece determined by the utilities of the ensemble, and determining corresponding label for the data piece based on a score/level of agreement between the utilities of the ensemble; and generating a third set including data pieces for which labels have been determined with agreement score/level above a selected threshold. The third set thus includes automatically labeled data pieces and can be used for training the primary machine learning utility.

Accordingly, due to the variations in topologies of machine learning utilities, the present technique may be configured for generating labeled data set including data pieces that are processed/inferred by the primary machine learning utility to provide label data within and outside acceptable range of agreement with labeled set of the ensemble. In some examples, the automatically labeled data is distributed between samples that the first utility inferred correctly (within the acceptable range of agreement with the ensemble) and samples where first utility made an error (outside of the acceptable range of agreement with the ensemble). In order to facilitate this, for each sample that the ensemble infers/labels, the first utility is also used to infer/label. The results of the two inferences are compared, and an agreement or disagreement between these inferences is recorded for each piece of data. This additional input is used when deciding which new labeled data pieces to add to the data set upon which to train the first/primary utility. For example, a first portion of the data set includes data pieces where the first utility agreed with the ensemble, while the remainder of the data set includes data pieces where the first utility disagreed with the ensemble. In this manner, training the first utility with the first portion of the data set reinforces the first utility's ability to continue correctly labeling data that it has already labeled correctly, while training the first utility of the remainder of the data set teaches the first utility to correctly label data that it has labeled incorrectly.

Therefore, an aspect of some embodiments of the present invention relates to a method for use in training a first learning utility. The method comprises: providing a first set of labeled data and an ensemble of second learning utilities; training the ensemble of second utilities to label data, using the first set of labeled data; providing a second set of unlabeled data; labeling at least one portion of the second set of unlabeled data using the ensemble in order to generate corresponding first labels for said at least one portion of the second set to thereby yield a third set of data pieces corresponding to said at least one portion of the second set and labels thereof; training the first utility using said third set of data pieces.

In some embodiments of the present invention, said training the first utility comprises using the third data set and the first set of labeled data.

In some embodiments of the present invention, said labeling at least one portion of the second set of unlabeled data comprises using said ensemble for determining labels to data pieces of said second set and manually validating said labels as correct, and retaining only data pieces are correctly labeled to form the third set of data pieces.

The second set of unlabeled data may be larger than the first set of labeled data. For example, the second set may be at least 10 times larger than the first set of labeled data.

According to some embodiments, the labeling of the at least one portion of the second set of unlabeled data is performed at least until a number of data pieces of the third set of data pieces exceeds a predetermined threshold.

Further, according to some embodiments, the labeling of the at least one portion of the second set of unlabeled data may comprise: using each of the second utilities to label each piece of data from the at least some data pieces, and assigning each data piece a score indicative of a number of second utilities that determined labels for the data piece within a predetermined similarity threshold; selecting for the third set of data pieces, only data pieces having respective scores higher than a predetermined threshold.

In some embodiments of the present invention, the method further comprises: using the first set of labeled data for training said first utility; using the first utility to automatically label the at least one portion of second set, to yield correspond second labels; comparing said second labels to said first labels of corresponding data pieces; selecting from the second set a first desired number of data pieces in which said second labels are within a range of agreement with said first labels to form a first part of said third set, and selecting from the second set a second desired number of data pieces in which said second labels are outside the range of agreement with said first labels to form a remainder of said third set, such that the data pieces of the third set are distributed as desired between said data pieces in which said second labels are within a range of agreement with said first labels and said data pieces in which said second labels are outside the range of agreement with said first labels.

In some embodiments of the present invention, the method further comprises repeating for a desired number of repetitions the providing the second set, the labeling, and the training, wherein: the labeling increases number of data pieces in the third set at every repetition; and training comprises training the first utility using the increased third set at every repetition.

In some embodiments of the present invention, the method further comprises retraining the ensemble to label data, using at least the third set.

Another aspect of some embodiments of the present invention relates to a method for use in generating labeled data sets. The method comprises: providing a first set of labeled data pieces and an ensemble comprising a plurality of learning utilities of selected topologies; using said first set of labeled data pieces for training the learning utilities of said ensemble, forming an ensemble of trained utilities; providing a second set of unlabeled data pieces, and using said plurality of trained utilities of the ensemble for determining corresponding labels to data pieces of said second set; processing said corresponding labels of the data pieces and determining scores associated with labels for said data pieces in accordance with labels determined by utilities of said ensemble, for each data piece gaining score above a predetermined threshold, determining a corresponding label; thereby generating said labeled data set. Typically, the ensemble may comprise three of more learning utilities.

According to some embodiments, the method may further comprise using said first set of labeled data pieces for training a first learning utility, using said first learning utility for inferring said second set of unlabeled data pieces, and determining corresponding scores associated with labels determined by said first learning utility to data pieces of said second set.

Generally, the second set may include amount of data pieces is at least 10 times greater with respect to amount of data pieces in said first set.

According to some embodiments, the method may further comprise selecting at least a portion of data pieces of said second set and manually validating the corresponding labels thereof.

A further aspect of some embodiments of the present invention relates to a system for use in training a learning utility. The system comprises one or more processing utilities, memory/storage utility and input/output communication module. Said one or more processing utilities comprises software and/or hardware module forming an ensemble of machine learning utilities, a scoring module and a data set aggregation module. The ensemble of machine learning utilities comprises at least two machine learning utilities, being configured for being trained using a first set of labeled data, and upon training, for receiving and processing input data pieces for generating one or more first labels for each piece in accordance with the training using said first set of data piece. The scoring module is configured for receiving output data from said two or more machine learning utilities in connection with labeling of a data piece and for processing said output data to assign corresponding scores to the first labels for the data piece, and comparing the assigned scores to a pre-provided threshold, for assigning a label to the data piece in accordance with first label having maximal score above the threshold, or for rejecting pieces of data with all first labels below the threshold, the data set aggregation module received data pieces with assigned labels for forming a third set of data pieces comprising data pieces to which corresponding labels have been assigned and the corresponding labels, and for storing the third set in the memory utility for use in training the learning utility.

According to some embodiments, the system further comprises a comparison utility, wherein: the first learning utility is configured for generating one or more second labels for each piece of data of a second set of unlabeled data; the comparison utility is configured for comparing the one or more second labels to the first labels assigned to each data piece of the second set, for selecting from the second set a first desired number of data pieces in which said second labels are within a range of agreement with said first labels to form a first part of said third set, for selecting from the second set a second desired number of data pieces in which said second labels are outside the range of agreement with said first labels to form a remainder of said third set.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a flowchart illustrating a method for training a first machine learning utility using an ensemble of second machine learning utilities, according to some embodiments of the present invention;

FIG. 2 is a flowchart illustrating a method for use in generating a labeled training data set, by processing output labels from each of the machine learning utilities of the ensemble, according to some embodiments of the invention.

FIG. 3 is a flowchart illustrating a method according to some embodiments of the present invention for training the first machine learning utility using an ensemble of second machine learning utilities, wherein the data used for training the machine learning utility includes data pieces in which the inferences of the first utility agree with the inferences of the ensemble and data pieces in which the inferences of the first utility disagree with the inferences of the ensemble;

FIG. 4 is a box diagram illustrating a system configured for training the first machine learning utility to label data; and

### DETAILED DESCRIPTION OF EMBODIMENTS

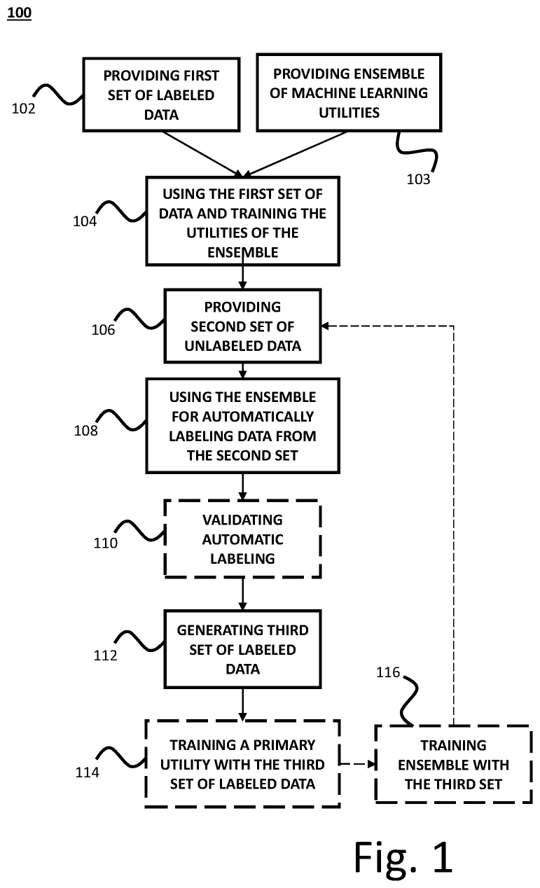

Referring now to the figures, FIG. 1 is a flowchart 100 illustrating a method for training a primary/first machine learning utility using training data labeled by an ensemble of second machine learning utilities, according to some embodiments of the present invention.

The method of FIG. 1 includes providing a first set of labeled data 102 and an ensemble of machine learning utilities 103; using the first set of labeled data and training the utilities of the ensemble 104; providing a second set of unlabeled data 106, and using the utilities of the ensemble for automatically labeling data pieces of the second set of data 108 to yield a third set of data; generating a third set of labeled data based on at least a portion of the data pieces of the second set 112, for which suitable labels have been determined; and using the third set for training the primary utility 114 is accordance with any preselected desired processing task. In some configurations, the method may also include manually validating the automatic labeling 110 determined by the utilities of the ensemble.

At 102, the first set of labeled data is provided. Generally, the first set of labeled data is a relatively small set that may be labeled manually. At 103 an ensemble of machine learning utilities is provided and at 104, the first set is used for training the ensemble of machine learning utilities.

Generally the ensemble of machine learning utilities includes a plurality of machine learning utilities having different topologies, hyper parameters and/or random initializations. Each machine learning utility of the ensemble may be associated with software and/or hardware processing modules. The different utilities of the ensemble may be associated with a common processing system, using one or more processors (e.g. dedicated processors for some utilities while other share processing time on a common processor) or include one or more utilities operated on one or more external/remote processors accessible via suitable communication path. The different utilities of the ensemble are trained for processing input data and determining corresponding output data indicative of labels of the input data, based on the training received via the first data set and labels thereof. To this end, each machine learning utility is configured for processing input data pieces and providing output data including selected parameters associated with labels of the input data (e.g. type of input data with certain likelihood values).

At 106, a second set of unlabeled data is provided. The second set of data is to be labeled automatically or semi-automatically for use (after being labeled) for training of a primary/first machine learning utility. As mentioned above, the accuracy of processing of a machine learning utility improves with the amount of data used for training thereof. Therefore, in some embodiments of the present invention, the second set of data is larger than the first set. The second set may be larger by a factor of 2, 5, 10, 100, 1000 or any other desired factor.

At 108, machine learning utilities of the ensemble are used for processing data pieces of the second data set and determining corresponding label data. Generally, data pieces of the second data set are being used as input data for the different utilities of the ensemble, where the desired output data relates to a label, or range of possible labels of the data pieces. For each data piece being processed, each of the different machine learning utilities generates corresponding output data, e.g. in the form of a vector of probabilities for different labels. Thus a plurality of vectors are generated from the plurality of utilities of the ensemble, each includes range of possible labels of the data piece. Generally, the so-generated output data is being processed for determining a level of agreement (score) of one (or in some configurations more than one) suitable label. If the score of a certain label exceeds a selected or predetermined threshold, the data piece is labeled accordingly. If the score of two or more selected labels exceeds the threshold for a certain data piece, the label having the highest score is used for labeling the corresponding piece of data.

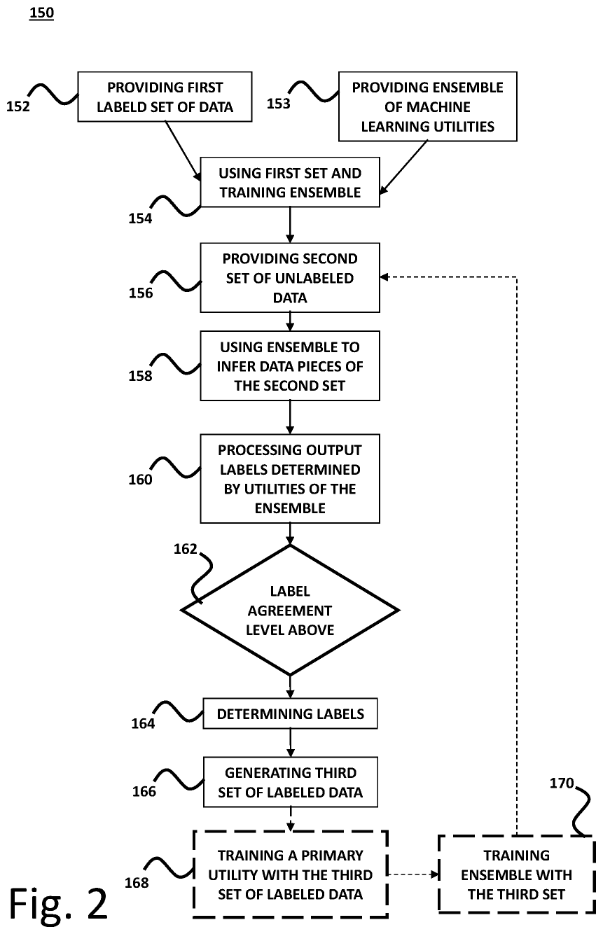

At 112, a third set of data pieces is generated. Generally, the ensemble may be used for automatically labeling all the data pieces of the second set, or a portion of the data pieces of the second set, as case may be, and thus varying amount/volume of data used for generating the third set of data pieces. The third set includes data pieces of the second set that have been successfully labeled by the ensemble and the corresponding labels of the data pieces. In some embodiments of the present invention, the creation of the third set of data pieces also includes setting the composition and/or size of the third set. More details about this will be given below, in the description of FIG. 2.

The third set of data generated at 112 is used for training a primary/first machine learning utility at 114. It is preferable that the amount of data pieces in the third set be sufficiently large to train the first/primary machine learning utility to have a desired accuracy in labeling data. It should be noted that the labeling of the data may or may not be the final purpose of the first utility. However, the first utility may be required to label input data in order to further process the data. Therefore, it is important that the first utility be able to label (recognize) input data with a desired accuracy.

In some configurations of the present invention, after the training of 114, the steps 106 to 114 are repeated, so that new unlabeled data is provided and automatically labeled by the ensemble, and the training of the primary/first utility is performed again with the newly labeled data pieces. In other configurations of the present invention, not all of the data provided at 106 is labeled in a single repetition. This may be because the amount of data provided is too large and would need too much time and/or processing power to label all at once. Therefore, only a portion of the data provided at 106 may be labeled at 108 and used for training the primary/first utility at 114.

In some embodiments of the present invention, the first utility is trained each time with the labeled data, the utilities of the ensemble are also retrained using the same data at 116. It is possible that even though the ensemble as a whole may have labeled the data pieces of the second set in a certain manner, one or more of the individual machine learning utilities of the ensemble may have labeled at least one data piece of the second set in a different (generally incorrect) manner Therefore, retaining the ensemble at 116 using the same data pieces already labeled by the ensemble ensures that all the individual machine learning utilities of the ensemble are trained to correctly label data pieces.

In some configurations of the method 100, the automatic labeling by the ensemble is manually validated at 110. The validation may include validating the labels for all the data pieces, or validating the labels for a portion/sample of the data pieces. If the manual validation shows that the agreement between the labeling by the ensemble and the manual labeling is within an acceptable range, then the correctly labeled data pieces are kept and form the third set. In a variant, if the manual validation shows a substantial disagreement between the labels assigned to the data pieces of the second set by the ensemble and the correct labels assigned by a human user, then the scoring and/or thresholds of the ensemble may be changed and the automatic processing of the results from the different utilities of the ensemble may be performed again with the new scoring and/or thresholds. In another variant, if the manual validation shows a substantial disagreement between the labels assigned to the data pieces of the second set by the ensemble and the correct labels assigned by a human user, then the ensemble is trained with more labeled data.

FIG. 2 is a flowchart 150 illustrating a method for training a machine learning utility using training data labeled by an ensemble of second machine learning utilities, according to some embodiments of the present invention. In the embodiment of flowchart 150, the labeling of the data pieces of the second set includes using the ensemble of infer data pieces of the second set 158, processing output labels determined by the utilities of the ensemble 160, checking whether the label agreement level processed is above a certain threshold 162, determining labels 164 according to the check of 162, and generating a third set of labeled data 166.

At 158, each of the machine learning utilities of the ensemble infers the same data pieces from the second set of unlabeled data. At 160, the output labels determined by all the utilities of the ensemble are processed together to yield a label agreement score for each data piece. At 162, a check is made for each data piece to determine whether for each data piece, the score of a label is above a certain threshold. The threshold may be predetermined, or may be determined by processing the scores yielded at 160.

For each data piece, the label having the highest score above the threshold is selected at 164. Data pieces in which no label has a score which exceeds the threshold are rejected. In this manner, the third set of labeled data is generated at 166.

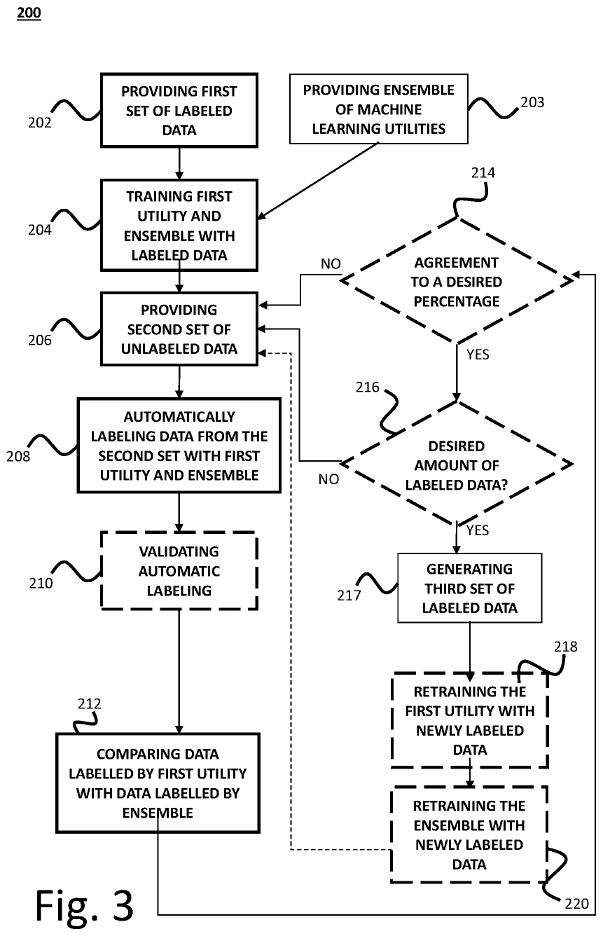

FIG. 3 is a flowchart 200 illustrating a method of some embodiments of the present invention for training the first machine learning utility to label data by using an ensemble of second machine learning utilities, wherein the data used for training the machine learning utility includes data pieces in which the inferences of the first utility agree with the inferences of the ensemble and data pieces in which the inferences of the first utility disagree with the inferences of the ensemble.

At 202, a first set of labeled data is provided, as explained above. At 203, an ensemble of machine learning utilities is provided, as described above. At 204, the first utility and the ensemble are trained using the first data. At 206, a second set of unlabeled data is provided, as explained above.

At 208, the data from the second set is automatically labeled separately by the first/primary utility and by the ensemble.

Optionally, at 210, the data automatically labeled by the first set is manually validated, as explained above.

At 212, the method includes comparing data labelled by the first utility with data labelled by the ensemble. The labels determined by the first utility are compared to the labels determined by the ensemble. The data pieces in which the labels determined by the first utility agree with the labels determined by the ensemble form a first group. The data pieces in which the labels determined by the first utility disagree with the labels determined by the ensemble form a second group.

At 214, a check may be set to assess whether the newly labeled data is formed by a desired percentage data pieces from the first group and a remainder of data pieces from the second group. In other words, the check of 214 assess whether the automatically labeled data is distributed as desired between samples that the first utility inferred correctly and samples where first utility made an error. The desired percentage or percentage range of the newly labeled data that is to be constituted by data pieces of the first group is predetermined. If the newly labeled data is distributed not as desired, the method returns to step 208 until the newly labeled data is distributed as desired between samples that the first utility inferred correctly and samples where first utility made an error. As mentioned above, using a desired distribution enables training the first utility to label various data types. This includes maintaining correct labeling of data pieces that the first utility already “knows” to label correctly, while teaching the first utility to label correctly types of data pieces that were labeled incorrectly (or with likelihood to be labeled incorrectly) when processed based on the initial training.

If the newly labeled data is distributed as desired, a second check may be set at 216 to determine whether the newly labeled data includes a desired amount of data (a desired quantity of data pieces). The desired amount is predetermined as well. If the newly labeled includes less than the desired amount of data, then labelling is performed again at 208. Using a desired amount of data enables balancing between using too little data (which may limit the accuracy of the primary/first utility) and using too much data (which may use too many processing resources and may be too costly to process all at once).

If the newly labeled data includes at least the desired amount of data, then the third set of data is generated at 217. Optionally, the first utility is retrained with the newly labeled data of the third set at 218, and optionally the ensemble is also retrained at 220, as described above. Optionally, the steps 206 to 220 are repeated as described above.

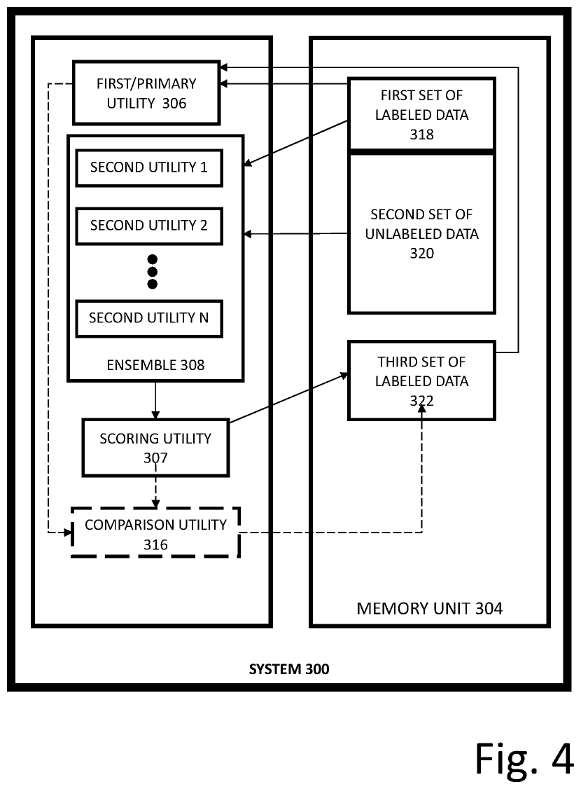

FIG. 4 is a box diagram illustrating a system 300 configured for training the first machine learning utility to label data.

The system 300 includes a processing unit 302 and a memory unit 300. The processing unit 302 and the memory unit 300 may include software and/or hardware modules. The processing unit 302 is configured for running the first machine learning utility 306 and the ensemble 308. The ensemble may include a number N of second utilities 310, 312, 314. The memory utility is configured for storing a first set of labeled data 318 and second set of unlabeled data 320. Generally, the processing unit may be configured by one or more processors. The Primary learning utility 306 as well as the ensemble of learning utilities may be operated as software or hardware modules by the one or more processors. Additionally, one or more of the learning utilities may be operated by a remote processing unit and the relevant module of processing unit 302 is configured to establish corresponding communication path (e.g. network communication).

As explained above, the first set of labelled data 318 is configured for training the ensemble 308 (and optionally the first utility 306) to label data. The each utility ensemble 308 is configured for separately determining labels for at least a portion of the second set 320. A scoring utility 307 is configured for scoring the labels determined by the different utilities of the ensemble 308 and for yield the third set of labeled data 322, as explained above. The data pieces forming the third set 322 are stored in the memory unit 304, as they are created.

In some embodiments of the present invention, the system 300 also includes a comparison utility 316 configured for comparing labels in data pieces labeled by the first utility 306 and the ensemble 308, and for distributing the data in the third data set 322 as desired between samples that the first utility 306 inferred within a certain agreement range with the ensemble and samples where the first utility 306 inferred outside the certain agreement range with the ensemble.

The processing unit 302 may include one processor or a plurality of processors. If the processing unit includes a plurality of processors, the processors may work together to run the same utility or may each separately run different utilities. The processing unit 302 and the memory unit 300 may be located close to each other and may be in wired or wireless communication. The processing unit 302 and the memory unit 300 may be located remotely from each other and connected via a network or via a cloud.

### Example

The present example illustrates the use of the technique the present invention for creating labeled images for an image classification task. The first machine learning utility is shown images of ten types of dogs and cats and will need to infer for each image what type of dog or cat it is.

The first utility includes a machine learning algorithm called CNN (convolutional neural network) with a well-known network topology called ResNet-50. The ensemble for labeling the data includes following networks:

ResNet-110

VGG16

Google Inception v4

SqueezeNet

These four networks were trained several times as follows, in order to yield forty-four different utilities:

Using all 10 of the labeled data for all of the classes (i.e., each network is trained in one manner in order to determine whether or not an image shows one of the ten different types of animals), and therefore yielding four utilities

Using 10 1 vs. many versions of the data, and therefore yielding 40 utilities. This will create 10 binary classifiers, each able to detect if an image is one of the 10 animals or not (i.e., each network is trained in ten manners, each manner corresponding to a different type of the 10 animals).

In total the ensemble will include 44 models.

The initial labeled data set contains a total of 10,000 images (1,000 images from each of the 10 classes). An additional unlabeled data set (second set of data) contains 1 million images. Optionally, the 1 million images may not all be available at the same time. For example, 10,000 unlabeled images may be initially available, and more images are collected while the 10,000 unlabeled images are processed by the primary and/or ensemble's utilities.

The following voting mechanism is implemented by the ensemble during inference of the unlabeled data:

1. Infer with the 4 utilities that were trained to detect all classes;
2. If less than 3 utilities agree on the inferred class then throw the sample away;
3. If 3 or more utilities agree, use the 4 relevant binary utilities;
4. In total there will be 8 votes for each sample. If 6 or more are in agreement then use the sample, otherwise throw it away

Since it is well known that a binary classifier will perform better on the specific class it is trained to detect than a multi class classifier, it is expected that this ensemble will provide a very strong classifier with low error rates.

Each selected sample will also be inferred using the primary ResNet-50 utility. Selected samples will be added to the labeled dataset so that 50% of them have agreement between the ensemble and the first utility.

After the labeling, at each repetition, the labeled database doubles in size, and the primary utility and the ensemble are retrained using the updated data base (i.e. at sizes 20000, 40000, 80000 and so on). The updated database may include data pieces upon which the primary utility and the ensemble's utilities have already been trained. Using these data pieces reinforces the training of the machine learning utilities, and ensures that the machine learning utilities do not “forget” their previous training.

1. A method for use in training a first learning utility, the method comprising:
providing a first set of labeled data and an ensemble of second learning utilities;
training the ensemble of second utilities to label data, using the first set of labeled data;
providing a second set of unlabeled data;
labeling at least one portion of the second set of unlabeled data using the ensemble in order to generate corresponding first labels for said at least one portion of the second set to thereby yield a third set of data pieces corresponding to said at least one portion of the second set and labels thereof;
training the first utility using said third set of data pieces.

2. The method of claim 1, wherein said training the first utility comprises using the third data set and the first set of labeled data.

3. The method of claim 1, wherein said labeling at least one portion of the second set of unlabeled data comprises using said ensemble for determining labels to data pieces of said second set and manually validating said labels as correct, and retaining only data pieces are correctly labeled to form the third set of data pieces.

4. The method of claim 1, wherein the second set of unlabeled data is larger than the first set of labeled data.

5. The method of claim 4, wherein said second set is at least 10 times larger than the first set of labeled data.

6. The method of claim 1, wherein said labeling the at least one portion of the second set of unlabeled data is performed at least until a number of data pieces of the third set of data pieces exceeds a predetermined threshold.

7. The method of claim 1, wherein said labeling the at least one portion of the second set of unlabeled data comprises:
using each of the second utilities to label each piece of data from the at least some data pieces, and assigning each data piece a score indicative of a number of second utilities that determined labels for the data piece within a predetermined similarity threshold;
selecting for the third set of data pieces, only data pieces having respective scores higher than a predetermined threshold.

8. The method of claim 1, further comprising:
using the first set of labeled data for training said first utility;
using the first utility to automatically label the at least one portion of second set, to yield correspond second labels;
comparing said second labels to said first labels of corresponding data pieces;
selecting from the second set a first desired number of data pieces in which said second labels are within a range of agreement with said first labels to form a first part of said third set, and selecting from the second set a second desired number of data pieces in which said second labels are outside the range of agreement with said first labels to form a remainder of said third set, such that the data pieces of the third set are distributed as desired between said data pieces in which said second labels are within a range of agreement with said first labels and said data pieces in which said second labels are outside the range of agreement with said first labels.

9. The method of claim 1, further comprising repeating for a desired number of repetitions the providing the second set, the labeling, and the training, wherein:
the labeling increases number of data pieces in the third set at every repetition; and
training comprises training the first utility using the increased third set at every repetition.

10. The method of claim 1, further comprising retraining the ensemble to label data, using at least the third set.

11. A method for use in generating labeled data sets, the method comprising:
providing a first set of labeled data pieces and an ensemble comprising a plurality of learning utilities of selected topologies;
using said first set of labeled data pieces for training the learning utilities of said ensemble, forming an ensemble of trained utilities;
providing a second set of unlabeled data pieces, and using said plurality of trained utilities of the ensemble for determining corresponding labels to data pieces of said second set;
processing said corresponding labels of the data pieces and determining scores associated with labels for said data pieces in accordance with labels determined by utilities of said ensemble, for each data piece gaining score above a predetermined threshold, determining a corresponding label; thereby generating said labeled data set.

12. The method of claim 11, further comprising, using said first set of labeled data pieces for training a first learning utility, using said first learning utility for inferring said second set of unlabeled data pieces, and determining corresponding scores associated with labels determined by said first learning utility to data pieces of said second set.

13. The method of claim 11, wherein said second set includes amount of data pieces is at least 10 times greater with respect to amount of data pieces in said first set.

14. The method of claim 11, further comprising selecting at least a portion of data pieces of said second set and manually validating the corresponding labels thereof.

15. The method of claim 11, wherein said ensemble comprising three of more learning utilities.

16. A system for use in training a learning utility, the system comprising one or more processing utilities, memory utility and input/output communication module; said one or more processing utilities comprise software and/or hardware module forming an ensemble of machine learning utilities, a scoring module and a data set aggregation module; the ensemble of machine learning utilities comprises at least two machine learning utilities, being configured for being trained using a first set of labeled data, and upon training, for receiving and processing input data pieces for generating one or more first labels for each piece in accordance with the training using said first set of data piece; the scoring module is configured for receiving output data from said two or more machine learning utilities in connection with labeling of a data piece and for processing said output data to assign corresponding scores to the first labels for the data piece, and comparing the assigned scores to a pre-provided threshold, for assigning a label to the data piece in accordance with first label having maximal score above the threshold, or for rejecting pieces of data with all first labels below the threshold, the data set aggregation module received data pieces with assigned labels for forming a third set of data pieces comprising data pieces to which corresponding labels have been assigned and the corresponding labels, and for storing the third set in the memory utility for use in training the learning utility.

17. The system of claim 16, wherein said one or more processing utilities further comprise a comparison utility and a primary machine learning utility, wherein:
the primary machine learning utility is configured for generating one or more second labels for each piece of data of a second set of unlabeled data;
the comparison utility is configured for comparing the one or more second labels to the first labels assigned to each data piece of the second set, for selecting from the second set a first desired number of data pieces in which said second labels are within a range of agreement with said first labels to form a first part of said third set, for selecting from the second set a second desired number of data pieces in which said second labels are outside the range of agreement with said first labels to form a remainder of said third set.
